(19) United States
(12) Patent Application Publication
(10) Pub. No.: US 2025/0165926 A1
(43) Pub. Date: May 22, 2025

(54) PLATFORM AND METHOD FOR COLLABORATIVE GENERATION OF CONTENT

(71) Applicant: NVIDIA Corporation, Santa Clara, CA (US)

(72) Inventors: Rev Lebaredian, Los Gatos, CA (US); Michael Kass, San Jose, CA (US); Brian Harris, Santa Clara, CA (US); Andrey Shulzhenko, Santa Clara, CA (US); Dmitry Duka, Santa Clara, CA (US)

(21) Appl. No.: 19/025,777

(22) Filed: Jan. 16, 2025

Related U.S. Application Data
(63) Continuation of application No. 16/538,594, filed on Aug. 12, 2019, now Pat. No. 12,211,005.
(60) Provisional application No. 62/717,730, filed on Aug. 10, 2018.

(51) Int. Cl. G06Q 10/10; G06T 15/00; G06T 19/00; G06T 19/20

(52) U.S. Cl. CPC G06Q 10/103; G06T 15/005; G06T 19/003; G06T 19/20; G06T 2219/024

(57) ABSTRACT

A cloud-centric platform is used for generating virtual three-dimensional (3D) content, that allows users to collaborate online and that can be connected to different software tools (applications). Using the platform, virtual environments (e.g., scenes, worlds, universes) can be created, accessed, and interacted with simultaneously by multiple collaborative content creators using varying content creation or development applications.

### RELATED U.S. APPLICATION

This application is a continuation of U.S. patent application Ser. No. 16/538,594, filed Aug. 12, 2019, which claims priority to U.S. Provisional Application No. 62/717,730, filed on Aug. 10, 2018. Each of which is hereby incorporated by reference in its entirety.

### BACKGROUND

Making high-quality three-dimensional (3D) worlds is difficult. Historically, 3D content creation pipelines (e.g., games, film, etc.) have been mostly linear. Due to concerns over consistency and fidelity, multiple content creators cannot work on the same asset simultaneously. Due to these constraints, large or immersive worlds are difficult, if not impossible. World size in particular has been historically limited due to the necessity of assets being client-side of each content-creator.

3D content is in high demand (e.g., for training autonomous vehicles and robots, for augmented reality, virtual reality, design, etc.). However, only a relatively small number of people or organizations have the skills and/or tools to make high-quality 3D worlds. In addition, the complexity of producing high quality 3D content is increasing as the number of contributions from traditionally distinct departments (e.g., 3D object modeling, world modeling, animation, physics, rendering, etc.) required to make 3D content that is vibrant, interesting, and attractive to consumers also continues to rise—all while the line among content creators, and even between content creators and content consumers, continues to blur.

### SUMMARY

Disclosed is, in general, a cloud-centric platform for generating virtual three-dimensional (3D) content that allows users to collaborate online and that can be connected to different software tools (applications). Using the platform, virtual environments (e.g., scenes, worlds, universes) can be created, accessed, and interacted with.

In embodiments, a server includes a database that stores assets comprising three-dimensional data useful for generating a virtual environment (e.g., a virtual scene), and also includes a synchronizer. The synchronizer can synchronize a change made by a client coupled to the server and data of the assets to include the change in the database, and can also synchronize changes in the database and data of clients coupled to the server.

The clients interoperate with each other to produce and modify the virtual environment. The clients include different types of clients that can operate on an object of the virtual environment in different ways.

In operation, in an embodiment, a first change to a first element of an asset is generated by a first application. The first element is updated in the database to include the first change. The first change is provided from the database to a second application. In response to the first change, a second change can be generated by the second application, in which case the database is updated to include the second change.

The platform thus allows collaborative, Web-based real-time editing through a published interface so that clients that are subscribers to an asset can work together on that asset or object. Subscribers can work together at the same time or at different times while a version control system is used to manage changes to maintain the integrity and fidelity of the work product from potentially multiple simultaneous accesses and/or collaborators.

From the point of view of the server and database, updates to an asset are provided from the clients as incremental updates (deltas) to the previous version of the asset. From the point of view of a client, updates to an asset from the server are also provided as deltas to the previous version of the asset. Consequently, network traffic and the computational loads on server and client devices are reduced. This advantageously provides the ability to perform bidirectional real-time updates between the clients and server for dynamic, complex virtual environments. Modifications to an environment can happen live, in real-time.

These and other objects and advantages of the various embodiments according to the present invention will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 is a block diagram illustrating a platform for collaboratively generating virtual 3D content in embodiments according to the present invention.

FIG. 2 is a block diagram illustrating selected components of a server in embodiments according to the present invention.

FIG. 3 is a block diagram illustrating the platform in a scalable framework (or engine) in embodiments according to the present invention.

FIG. 4 is a block diagram illustrating the use of a database to create multiple virtual environments in embodiments according to the present invention.

FIG. 5 is a block diagram illustrating the use of the database for virtual environment forking in embodiments according to the invention.

FIG. 6 is a flowchart of an example of a computer-implemented method for collaborative generation of content in embodiments according to the present invention.

FIG. 7 is a block diagram illustrating the flow of information between the server and clients in embodiments according to the present invention.

FIG. 8 is a block diagram illustrating an example computing system upon which embodiments according to the present invention can be implemented.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “saving,” “changing,” “updating,” “synchronizing,” “providing,” “performing,” “making a change,” “generating,” “rendering,” “identifying,” “loading,” “resolving,” “displaying,” “assembling,” “accumulating,” “receiving,” “sending,” or the like, refer to actions and processes of an apparatus or computer system or similar electronic computing device or processor. A computer system or similar electronic computing device manipulates and transforms data represented as physical (electronic) quantities within memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory (e.g., a solid-state drive) or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

### Overview

Disclosed is, in general, a cloud-centric platform for generating virtual three-dimensional (3D) content, that allows users to collaborate online and that can be connected to different software tools (applications). Using the platform, virtual environments (e.g., scenes, worlds, universes) can be created, accessed, and interacted with.

In embodiments, one or more applications (e.g., Web-based applications) are communicatively coupled to a database that can be accessed, edited, and stored. A wide variety of third-party applications can connect as seamlessly as possible or practicable with the database, and vice versa, through well-designed application programming interfaces (APIs). In embodiments, at least one of the applications is a 3D content creation application (e.g., an animation tool or a computer graphics application such as Autodesk Maya®).

In embodiments, the database is based on the Universal Scene Description (USD) format and schema. The entries or elements in the database are referred to herein as “assets.” Objects in a virtual 3D environment, and the virtual environment itself, can be composed from one or more of the elemental assets. The database can be queried and updated using the applications. Appropriate plug-ins are created and used for applications, to allow those applications to operate smoothly for real-time editing.

As will be described in greater detail, each application interacts with certain attributes or properties of objects that can be described or defined using the assets in the database. For example, a graphics editor (e.g., Photoshop®) can be connected to the database (to an asset in the database) using a plug-in to add a texture to an object in a virtual scene, while a computer graphics application or animation tool (e.g., Autodesk Maya®) can be connected to the database (to an asset in the database) using a plug-in to animate that object (or a different object) in the virtual scene. In other words, an object created with a first application such as Maya® can have associated properties understood only by that application, but the disclosed platform supports the ability for a second application (e.g., Photoshop®) to make changes to that object, while advantageously leaving the properties understood only by the first application undisturbed. The two applications can thus interoperate, essentially interacting with each other, without being directly connected to each other or being aware of each other. More than two applications can interoperate or collaborate in this manner.

Subscribers can identify what assets or objects are of interest to them, and make changes where they have permission to do so. The platform allows collaborative, Web-based real-time editing through a published interface so that subscribers to an asset can work together on that asset or object. Subscribers can work together at the same time or at different times. A version control system is used to manage changes.

### Platform and Method for Collaborative Generation of Content

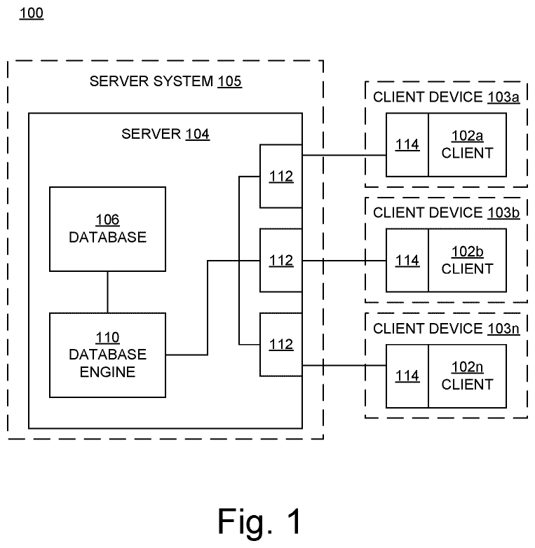

FIG. 1 is a block diagram illustrating a platform 100 for collaboratively generating virtual 3D content in embodiments according to the present invention. The platform 100 can be implemented as computer-executable components stored in non-transitory computer-readable media.

In embodiments, the platform 100 includes a system of clients 102a-n, which are applications or software tools that can be executed on or using one or more computing systems (the client devices or systems 103a-n). The client devices 103a-n can include different types of devices; that is, they may have different computational and display capabilities and different operating systems, for example. Depending on their hardware and software capabilities, the client devices 103a-n may be referred to as either a thick client or a thin client.

The platform 100 also includes a server 104 communicatively coupled to the clients 102a-n. The server 104 can be executed on or using one or more computing systems (e.g., the server system 105).

Generally speaking, in embodiments, the platform 100 is implemented as a cloud-centric platform; that is, it is a Web-based platform that can be implemented using one or more devices connected and working cooperatively via a network (e.g., the Internet).

In an embodiment, each of the clients 102a-n connects to the server 104 through a port or socket 112, and communicates with the server using a common application programming interface (API) that enables bidirectional communication (e.g., the WebSockets API). The clients 102a-n include different types of applications such as, but not limited to: a physics simulation application, an artificial intelligence (AI) application, a global illumination (GI) application, a game engine, a computer graphics application, a renderer, a graphics editor, a virtual reality (VR) application, an augmented reality application, and a scripting application. Because they are different from each other, the clients 102a-n can be called “heterogeneous clients.” The clients 102a-n may also be referred to as “microservices.”

In embodiments, the server 104 includes a database 106. Although referred to singularly as a database, the database 106 can include multiple databases that are implemented and stored on one or more computing systems (e.g., a datacenter). The database 106 stores data representative of assets. Each asset stores 3D data that can be used with other assets to compose a virtual scene. Virtual scenes can be combined to form virtual worlds or universes. In general, the term “virtual environment” is used herein to refer to a virtual scene, world, or universe. Use cases include, but are not limited to: design reviews for product design and architecture; scene generation; scientific visualization (SciVis); automobile simulation (e.g., AutoSIM); cloud versions of games; virtual set production; and social VR with user-generated content and elaborate worlds.

There may be different servers inside the platform 100 for different virtual environments, and the owner of a virtual environment may make choices about the way the environment is constructed and which resources are provided in order to provide the most relevant and important scalability.

Each asset in the database 106 can be accessed and optionally changed by one or more of the clients 102a-n. In an embodiment, the clients 102a-n are connected to the database using a respective plug-in 114. However, in embodiments, access to an asset is limited to clients that subscribe to that asset, and a change to an asset can only be made by a subscriber that has permission to do so.

Not all of the clients 102a-n are applications that can make changes to assets in the database 106. For example, the clients 102a-n may include applications that render an asset or environment, and may include applications that display an asset or environment.

The platform 100 leverages the cloud. The platform 100 factors out asset storage, editing, and querying into a cloud service (the database 106). The platform 100 allows virtually any application to connect to the server 104.

In embodiments, the server 104 also includes a synchronizer 108. As mentioned above, one or more of the clients 102a-n can make changes to an asset. The synchronizer 108 synchronizes those changes with the data of the asset, and also synchronizes the data of the changed (updated) asset with other clients interested in that asset (e.g., other subscribers to the asset).

More specifically, in embodiments, an asset can be loaded across a network from the server 104 to a first client 102a. The client 102a can make a change or changes (an update) to the asset. In embodiments according to the invention, after the update is made, the client 102a advantageously loads and saves to the database 106 only the update to the asset. That is, the client 102a does not return the entire, updated asset to the database 106; instead, the client 102a saves only the part(s) (e.g., object, property, attribute) of the asset that changed. In turn, the changes to the asset can be provided to one or more of the other clients 102b-n that, for example, subscribe to that asset. That is, the database 106 does not provide the entire, updated asset to the other clients; instead, the database provides only the part(s) (e.g., object, property, attribute) of the asset that changed. The synchronization process in which only changes are shared between the database 106 and the clients 102a-n may be referred to herein as “incremental updates” or “incremental changes.”

Thus, from the point of view of the server 104 (specifically, the database 106), updates to an asset are provided from the clients 102a-n as incremental changes (deltas) to the previous version of the asset; and, from the point of view of a client, updates to an asset from the server are also provided as deltas to the previous version of the asset. Consequently, network traffic and the computational loads on server and client devices are reduced. This advantageously provides the ability to perform bidirectional real-time updates between the clients 102a-n and server 104 for dynamic, complex virtual environments. Modifications to an environment can happen live, in real time. Any runtime can connect to the server 104 and see live updates to the environments.

To summarize to this point, the server 104 enables the clients 102a-n to publish and subscribe to any asset in the database 106 for which the clients have suitable permissions. In use, multiple clients 102a-n can publish and subscribe to the same set of assets, creating a shared virtual world. The database 106 operates, in essence, as a hub that allows the clients 102a-n to interoperate with each other through changes to the database. Plug-ins 114 for the clients 102a-n allow the clients to interoperate with the database 106 and with each other through the database. The clients 102a-n can be heterogeneous (different types of) applications that are able to work together through the database 106. Updates from any one of the clients 102a-n can be replicated to the database 106 then to the other clients at interactive speeds.

Thus, in embodiments according to the present invention, each client (application) 102a-n interacts with certain attributes or properties of objects that can be described or defined using the assets in the database 106. In the example described earlier herein, a graphics editor (e.g., Photoshop®) can be connected to the database 106 (to an asset in the database) to add a texture to an object in a virtual scene, and a computer graphics application or animation tool (e.g., Autodesk Maya®) can be connected to the database (to an asset in the database) to animate that object (or a different object) in the virtual scene.

In embodiments, a change to an asset in the database 106 made by one of the clients (application) 102a-n prompts each subscriber to consider the change. That is, in embodiments, a subscriber processes or performs operations in response to being notified of the change or by receiving the change (e.g., by synchronizing with the database 106). For example, an animation tool (e.g., Autodesk Maya®) can be used to animate an object in a virtual scene, and a physics simulation application or physics engine (e.g., PhysX) can be used to simulate real-world physics associated with the object in the virtual scene. In this example, if the animation tool is used to, for instance, move the object over the edge of a table and updates the asset in the database 106 accordingly, then (e.g., after synchronizing with the database) the physics simulation application will automatically simulate real-world physics based on that movement (e.g., the trajectory of the falling object) and update the database accordingly. Thus, an asset in the database 106 can be changed by a type of first client, and a second client (that may be a different type of client) can also change that asset (perhaps in direct response to the change made by the first client). In this manner, two or more clients (e.g., different types of clients) can interoperate, essentially interacting with each other, to effect changes to different properties or attributes of the same asset.

However, depending on the type of client, a change to an asset provided to the client does not necessarily trigger another change to either that asset or another asset. In general, in response to being provided a change to an element of an asset, a client can make another change to that element, and update the database 106 to include the other change; make a change to another element of the asset, and update the database to include the change to the other element; use the element including any change in some type of operation that does not cause another change to the element; render the element/asset; and/or display the element/asset.

In embodiments, the platform 100 (e.g., the server 104) also includes a database engine 110 that can resolve conflicts between changes to the database 106. The database engine 110 functions as a change or version control mechanism. In an embodiment, conflicts are resolved according to a ranking assigned to the clients 102a-n, which may be referred to as source control. That is, if for example two clients are subscribers to an asset and both have permission to change the asset, the changes from one of the clients have priority over and would supersede any conflicting changes from the other client. Priorities can be assigned in different ways. For example, one client can have priority over one spatial portion of a virtual environment, and another client can have priority over another spatial portion of the virtual environment. In that case, if an asset appears or is used in one area of the virtual environment, then the changes from the first client would have priority over conflicting changes from the second client; but if the asset appears or is used in the other area of the virtual environment, then the changes from the second client would have priority.

As mentioned above, in embodiments, the database 106 is based on the USD format and schema. USD provides the ability to layer together a series of “opinions” about properties for collections of objects. A layer is a group of objects that are outside of a conventional tree structure of transformation hierarchy; that is, the objects may be included in different leaves of the transformation hierarchy. Layering allows properties across objects in the layer (group) to be changed. For example, the engine and the doors of a car may be represented as different objects in the transformation hierarchy; however, the engine and the doors can both include screws. Layers permit the properties of the screws to be changed no matter where the screws appear in the hierarchy. In embodiments, different client subscribers may have control over respective layers, in which case their updates take precedent over the updates of other subscribers. Different layers may be ranked higher than other layers; the ranking can be used to control which changes to a layer have priority.

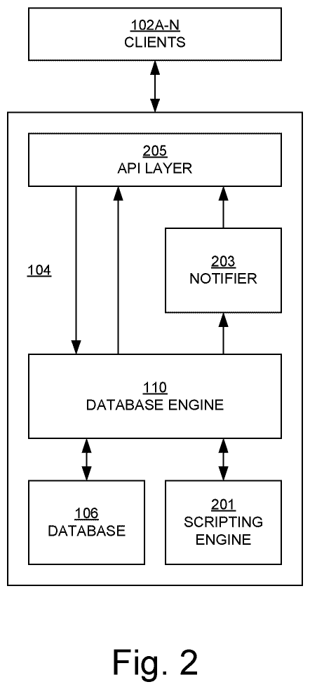

FIG. 2 is a block diagram illustrating selected components of the server 104 in embodiments according to the invention. As described above, in embodiments, the server 104 includes the database 106 and the database engine 110. Clients 102a-n (e.g., applications) can query and modify the database 106, for example, through an API layer 205 (e.g., the sockets 112 of FIG. 1).

In an embodiment, a scripting engine 201 runs lightweight and safe (e.g., sandboxed) scripts close to the database 106 without passing through the API layer. In an embodiment, procedural data-flow elements are created, submitted, and linked in the server 104. The individual procedural elements can be specified in ways similar to the way procedural shaders are specified.

Updates to assets in the database 106 are communicated back to clients that are subscribers to those assets. In an embodiment, a notifier 203 sends a message to the clients that subscribe to an asset when that asset is changed. In effect, notifications are filtered per client based on what is of interest to the client.

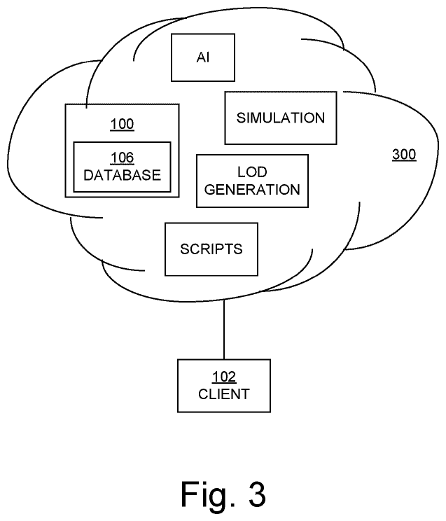

FIG. 3 is a block diagram illustrating the platform 100 in a scalable framework (or engine) 300 in embodiments according to the present invention. The scalable framework 300 can manage and launch application-defined processes near the database 106, such as but not limited to physics simulation, AI, GI, and level-of-detail (LOD) generation.

In an embodiment, the framework 300 includes a replication engine (not shown). For speedy replication, where correctness requires locks, API calls can be used with guaranteed correctness. A client 102 can take a snapshot and get a fully correct set of data at a particular moment suitable for offline rendering at the highest quality. All relevant static assets are not necessarily preloaded. Teleporting is an important use case, and framework 300 provides the ability to go quickly to non-preloaded places. Certain applications (clients) may choose to preload all relevant assets, but that is not necessarily imposed on all applications.

In an embodiment, the framework 300 includes an API to support data-flow dependencies, caching, and re-computation, for situations where, for example, a computation depends on a set of properties, objects, or a volume of space and should be updated when they change (e.g., GI computations, LOD, and potentially visible sets).

In an embodiment, the framework 300 includes an API for spatial queries.

In an embodiment, the framework 300 includes software tools for authoring and running procedural scripting in the cloud to create behavior, including APIs for, but not limited to: registering scripts, setting up events, and triggers. These may be containerized and linked by permissions to a particular virtual environment.

In an embodiment, the framework 300 includes APIs to aid in the creation of very large worlds including APIs for, but not limited to: LODs, auto-creation of distant environment maps, and visibility culling.

Using the framework 300, cloud rendering can be provided for a wide variety of experiences. The platform 300 can be used for applications where the minimum specification of rendering power can be very high, even when sending the result to a thin (e.g., mobile) client device.

Thin VR clients are also supported by, for example, cloud rendering RGB-D videos wider than the field-of-view and also by transmitting supplemental hole-filling data from nearby viewpoints. Thus, during a period when a client has stale data, it can re-project the stale data from the new viewpoint using the depth and hole-filling data to create appropriate parallax. In a gaming application, common calculations (e.g., GI and physics) between clients can be naturally factored out. View-dependent calculations (e.g., final render, user experience (UX), physics, GI, and LOD) can be done separately in the cloud and streamed to thin clients outside the cloud.

The platform 300 can also support latency-sensitive experiences that may benefit greatly from, for example, thick clients over wide area networks (WANs), although the invention in not so limited. Massively multiplayer online games (MMOs) and their relatives are also supported.

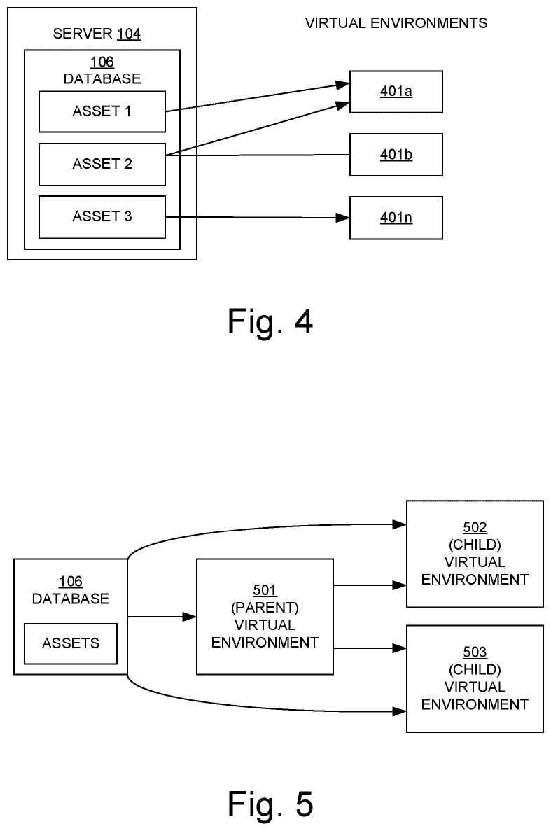

FIG. 4 is a block diagram illustrating the use of the database 106 to create multiple virtual environments 401a-n in embodiments according to the invention. In the example of FIG. 4, assets 1-3 in the database can be referenced by different environments. Thus, for example, asset 2 is referenced by, and used to create, both of the virtual environments 401a and 401b.

FIG. 5 is a block diagram illustrating the use of the database 106 for virtual environment forking in embodiments according to the invention. Forking virtual environments into multiple child environments (copies) is a relatively inexpensive (computationally) operation. References to assets in the database 106 are moved from the parent environment 501 to the child environments 502 and 503.

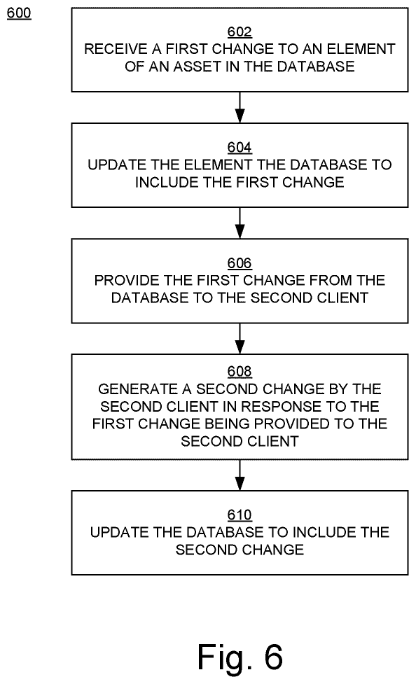

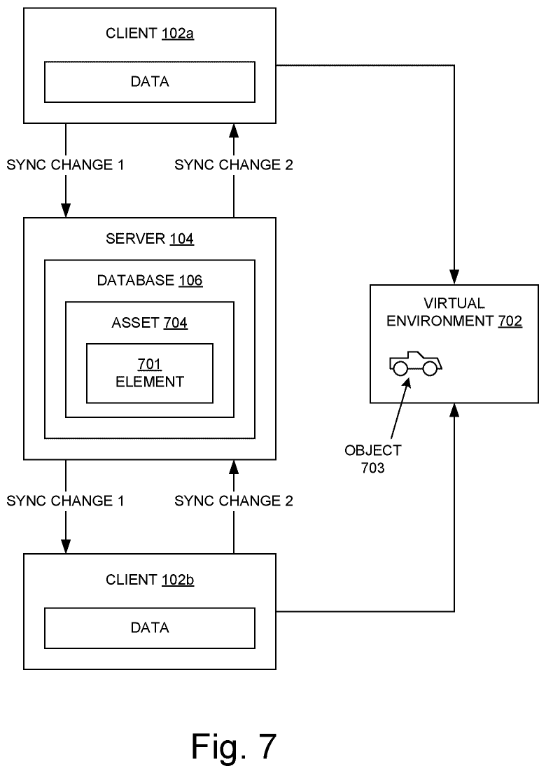

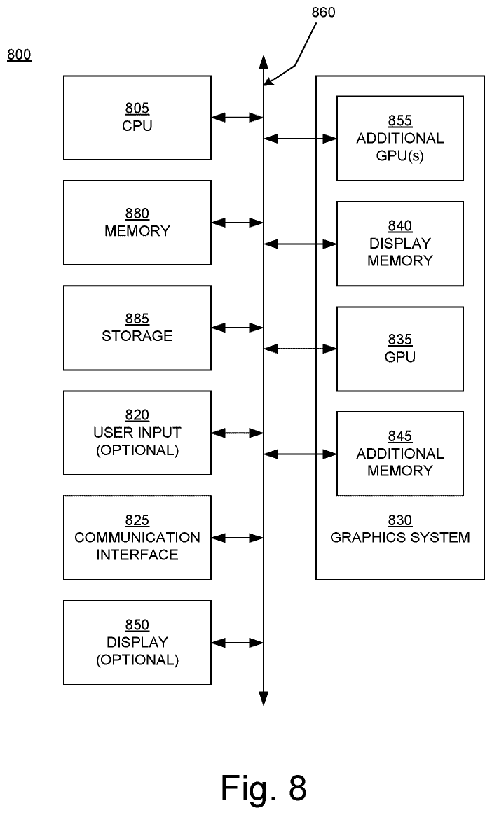

FIG. 6 is a flowchart 600 of an example of a method for collaborative generation of content in embodiments according to the invention. The flowchart 600 can be implemented as computer-executable instructions residing on some form of computer-readable storage medium (e.g., in memory of the computing system 800 of FIG. 8). In embodiments according to the present invention, the method of FIG. 6 is performed by (at) the server 104 of FIG. 1. FIG. 6 is described in conjunction with FIG. 7, which is a block diagram illustrating the flow of information between the server 104 (specifically, the database 106) and two clients 102a and 102b in embodiments according to the invention. The discussion below can be readily extended to more than two clients.

In block 602 of FIG. 6, a first change (change 1) to an element 701 (e.g., property or attribute) of an asset 704 in the database 106 is received. The first change is generated by the first client 102a (a first application). In the example of FIGS. 6 and 7, the asset 704 (and element 701) are associated with an object 703 in a virtual environment (scene) 702. That is, a change to the element 701 can affect, for example, the appearance, position, or orientation of the object 703 in the virtual environment 702.

In block 604, the element 701 is updated in the database 106 to include the first change. In embodiments, the database 106 is updated by synchronizing the database and data of the client 102a.

In block 606, the first change is provided from the database 106 to the client 102b (a second application). In embodiments according to the invention, only the change or changes to the element 701 are provided from the database 106 to the client 102b: the entire, updated element—or the entire, updated asset 704—is not provided from the database to the client 102b. In an embodiment, the client 102b subscribes to the asset or to the element 701. In an embodiment, the clients 102a and 102b are different types of clients. The clients may be directed to different aspects of content creation or asset management, or may be used on different scales, or modalities. For example, one client may operate on one or more two-dimensional spaces, whereas another client may execute in a three-dimensional space. The same asset could appear to the first client as a series of discrete two-dimensional object geometries, whereas the latter client may visualize the asset three-dimensionally (e.g., through a virtual reality device) with perspectives of the asset that can be interactively and contiguously traversed. In an embodiment, the server 104 sends a message to the client 102b when a change to the asset or to the element 701 is saved to the database 106. In embodiments, the first change is provided by synchronizing the database 106 and data of the client 102b. The first change can also be provided to other clients that subscribe to the element 701.

In an embodiment, the second change triggers (prompts) the second client 102b to perform operations (execute) in order to process or analyze the effect (if any) of the first change. In block 608, in an embodiment, a second change (change 2) is generated by the second client 102b in response to the first change being provided to the second client. In an embodiment, the second change is based on the first change. The change made by the second change may be to the element 701 or to a different element (of the asset 704 or of a different asset) affected by the first change.

In block 610, the database 106 is updated to include the second change. In embodiments, the database 106 is updated by synchronizing the database and data of the client 102b. In embodiments according to the invention, only the change or changes to the element 701 (or the other element) are provided to the database 106 by the client 102b: the entire, updated element—or the entire, updated asset—is not provided to the database by the client 102b.

The second change can be provided to the client 102a, by synchronizing the database 106 and data of the client 102a, by synchronizing the database and data of the client 102a.

In the manner just described, the clients 102a and 102b interoperate with each other through changes to the database 106 to collaboratively generate content (the virtual environment 702 and object 703). In an embodiment, one of the client applications 102a-n (FIG. 1) can render the virtual environment 702 for different types of client devices 103a-n (which may be referred as heterogeneous client devices) and adapt the rendering according to the respective hardware and software capabilities of the client devices.

Thus, in essence, instead of a client loading an asset to local memory, the asset is loaded from the database 106 across a network to the client; and, when a change is made, instead of saving the change to local memory, the change is saved across the network to the database. However, a client can make and register (list) multiple changes to an asset before saving any of the changes to the database 106. In other words, a client can save a single change to the database 106, or it can save a group of changes to the database. In an embodiment, the client can save changes to a database at a rate that corresponds to how the virtual environment is to be rendered and displayed. For example, in a video or gaming application that renders and displays scenes at the rate of 60 frames per second, clients may save changes at the rate of 60 times per second.

Depending on the type of client, a change to an element provided to the client does not necessarily trigger another change to either that element or another element. In general, in response to being provided a change to an element of an asset, a client 102a-n can make another change to that element, and update the database 106 to include the other change; make a change to another element of the asset, and update the database to include the change to the other element; use the element including any change in some type of operation that does not cause another change to the element; render the element/asset; and/or display the element/asset.

### Example Computing System

FIG. 8 is a block diagram illustrating an example computing system 800 upon which embodiments according to the present invention can be implemented. The computing system 800 may be, but is not limited to, a computer. The client devices 103a-n and the server system 105 can be implemented using the computing system 800. However, the client devices 103a-n and the server system 105 may not include all of the components of the computing system 800, and/or may include components in addition to those described below.

FIG. 8 is a block diagram of an example of a computing system 800 capable of implementing embodiments according to the present invention. In the example of FIG. 8, the computing system 800 includes a central processing unit (CPU) 805 for running software applications and optionally an operating system. Memory 810 stores applications and data for use by the CPU 805. Storage 815 provides non-volatile storage for applications and data and may include fixed disk drives, removable disk drives, flash memory devices, and CD-ROM, DVD-ROM or other optical storage devices.

With reference also to FIG. 1, the memory 810 and/or the storage 815 includes non-transitory computer-readable media having computer-executable components for implementing the clients 102a-n or the server 104, depending on the implementation.

The user input 820 of FIG. 8 includes devices that communicate user inputs from one or more users to the computing system 800 and may include keyboards, mice, joysticks, touch screens, and/or microphones. The communication or network interface 825 allows the computing system 800 to communicate with other computing systems via an electronic communications network, including wired and/or wireless communication and including the Internet. The display device 850 is any device capable of displaying visual information in response to a signal from the computing system 800. The components of the computing system 800, including the CPU 805, memory 810, data storage 815, user input devices 820, communication interface 825, and the display device 850, are connected via one or more data buses 860.

In the FIG. 8 embodiment, a graphics system 830 is connected with the data bus 860 and the components of the computing system 800. The graphics system 830 may include a physical graphics processing unit (GPU) 835 and graphics memory. The GPU 835 generates pixel data for output images from rendering commands. The physical GPU 835 can be configured as multiple virtual GPUs that are used in parallel (concurrently) by a number of applications executing in parallel.

Graphics memory may include a display memory 840 (e.g., a framebuffer) used for storing pixel data for each pixel of an output image. In another embodiment, the display memory 840 and/or additional memory 845 are part of the memory 810 and are shared with the CPU 805. Alternatively, the display memory 840 and/or additional memory 845 can be one or more separate memories provided for the exclusive use of the graphics system 830.

In another embodiment, graphics processing system 830 includes one or more additional physical GPUs 855, similar to the GPU 835. Each additional GPU 855 is adapted to operate in parallel with the GPU 835. Each additional GPU 855 generates pixel data for output images from rendering commands. Each additional physical GPU 855 can be configured as multiple virtual GPUs that are used in parallel (concurrently) by a number of applications executing in parallel.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The example methods described and/or illustrated herein may also omit one or more of the steps described or illustrated herein or include additional steps in addition to those disclosed.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the disclosure.

Embodiments according to the invention are thus described. While the present disclosure has been described in particular embodiments, it should be appreciated that the invention should not be construed as limited by such embodiments, but rather construed according to the below claims.

What is claimed is:

1. A method comprising:
receiving, via at least one client accessing a scene, changes to at least one asset of the scene;
storing a representation of a synchronized version of the scene that corresponds to the changes;
providing at least two different clients with different sets of the changes, wherein the different sets of the changes cause the at least two different clients to determine different sets of property values of the at least one asset from the synchronized version of the scene; and
causing the at least two different clients to render one or more portions of the synchronized version of the scene that includes the at least one asset using respective different sets of property values.

2. The method of claim 1, wherein a first set of the different sets of property values corresponds to a same object in the scene as a second set of the different sets of property values.

3. The method of claim 1, wherein a first set of the different sets of property values includes a different property value for a property of an asset than a property value for the same property of the same asset in a second set of the different sets of property values.

4. The method of claim 1, wherein a first set of the different sets of property values includes a same property value for a same property included in a second set of the different sets of property values.

5. The method of claim 1, wherein a first client of the at least two different clients uses a first set of the different sets of property values to produce and render a first composition of the scene and a second client of the at least two different clients uses a second set of the different sets of property values to produce and render a second composition of the scene.

6. The method of claim 1, wherein the at least two different clients are provided with the different sets of the changes based at least on the different clients having different subscriptions that correspond to different properties of the scene.

7. The method of claim 1, wherein the property values are defined across a plurality of layers that define the scene, and the at least two different clients are provided with the different sets of the changes based at least on associating the different clients with different sets of the layers.

8. The method of claim 1, wherein the different sets of property values include one or more of:
one or more geometric properties corresponding to the scene;
one or more transform properties corresponding to the scene;
one or more material properties corresponding to the scene;
one or more physics properties corresponding to the scene; or
one or more animation properties corresponding to the scene.

9. The method of claim 1, wherein the clients correspond to one or more of:
a physics simulation application;
an artificial intelligence application;
a global illumination application;
a game engine;
an animation tool;
a computer graphics application;
a renderer;
a graphics editor;
a virtual reality application;
an augmented reality application; or
a scripting application.

10. The method of claim 1, wherein the changes are stored using the representation at a rate that corresponds to a frame rate that at least one client of the clients uses to render and display the one or more portions of the synchronized version of the scene.

11. A system comprising:
one or more processors to perform operations including:
receiving, via at least one client application accessing a scene, changes to at least one asset of the scene;
storing a representation of a synchronized version of the scene that corresponds to the changes;
providing at least two different client applications with different sets of the changes, wherein the different sets of the changes cause the at least two different client applications to determine different sets of property values of the at least one asset from the synchronized version of the scene; and
causing the at least two different clients to render one or more portions of the synchronized version of the scene that includes the at least one asset using respective different sets of property values.

12. The system of claim 11, wherein a first set of the different sets of property values corresponds to a same object in the scene as a second set of the different sets of property values.

13. The system of claim 11, wherein a first set of the different sets of property values includes a different property value for a property of an asset than the property value for the same property of the same asset in a second set of the different sets of property values.

14. The system of claim 11, wherein a first set of the different sets of property values includes a same property value for a same property included in a second set of the different sets of property values.

15. The system of claim 11, wherein the system is comprised in at least one of:
a system for performing one or more simulation operations;
a system for performing light transport simulation;
a system for performing collaborative content creation for 3D assets;
a system for performing one or more AI operations;
a system for generating synthetic data;
a system for presenting at least one of virtual reality content or augmented reality content;
a system implemented at least partially in a data center; or
a system implemented at least partially using cloud computing resources.

16. At least one processor comprising:
one or more circuits to cause at least two different clients of a collaborative content creation platform to render one or more portions of a synchronized version of a scene that includes at least one asset using respective different sets of property values, the rendering being based at least on:
receiving, via at least one client accessing a scene, changes to the at least one asset of the scene;
storing a representation of a synchronized version of the scene that corresponds to the changes; and
providing the at least two different clients with different sets of the changes.

17. The at least one processor of claim 16, wherein a first set of the different sets of property values corresponds to a same object as a second set of the different sets of property values.

18. The at least one processor of claim 16, wherein a first set of the different sets of property values includes a different property value for a property of an asset than a property value for the same property of the same asset in a second set of the different sets of property values.

19. The at least one processor of claim 16, wherein a first set of the different sets of property values includes a same property value for a same property included in a second set of the different sets of property values.

20. The at least one processor of claim 16, wherein the at least one processor is comprised in at least one of:
a system for performing one or more simulation operations;
a system for performing light transport simulation;
a system for performing collaborative content creation for 3D assets;
a system for performing one or more AI operations;
a system for generating synthetic data;
a system for presenting at least one of virtual reality content or augmented reality content;
a system implemented at least partially in a data center; or
a system implemented at least partially using cloud computing resources.
